(19) United States
(12) Patent Application Publication
(10) Pub. No.: US 2021/0185080 A1
(43) Pub. Date: Jun. 17, 2021

(54) SOCIAL ENGINEERING ATTACK PREVENTION

(71) Applicant: AT&T Intellectual Property I, L.P., Atlanta, GA (US)

(72) Inventors: Wei Wang, Harrison, NJ (US); Mikhail Istomin, Brooklyn, NY (US); Chaim Spielman, Spring Valley, NY (US); Christina Monteleone, Long Branch, NJ (US); Kenneth Walsh, Helmetta, NJ (US); Carol Pincock, Salt Lake City, UT (US)

(21) Appl. No.: 16/710,331

(22) Filed: Dec. 11, 2019

(51) Int. Cl. H04L 29/06; G06N 3/08; G06N 3/04

(52) U.S. Cl. CPC H04L 63/1441; G06N 3/0445; G06N 3/0454; G06N 3/08

(57) ABSTRACT

In one example, the present disclosure describes various methods, computer-readable media, and apparatuses for supporting social engineering attack prevention based on early detection and remediation of various types of social engineering attacks which may be initiated within various contexts. In one example, supporting social engineering attack prevention may include identifying a workflow to be protected, identifying, for the workflow, a set of valid resources of the workflow where the set of valid resources includes a set of artifacts and a set of templates, identifying, from a dataset associated with the workflow and based on the set of artifacts, a communication associated with the workflow, determining, based on an analysis of the communication based on the set of templates, that the communication is malicious, and initiating, based on the determination that the communication is malicious, a remediation action.

### TECHNICAL FIELD

The present disclosure relates generally to communication networks, and more particularly to methods, computer-readable media, and apparatuses for supporting prevention of social engineering attacks in corporate networks.

### BACKGROUND

Social engineering attacks against corporations, including against employees of the corporations as well as customers of the corporations, is an ongoing problem that is projected to worsen.

### BRIEF DESCRIPTION OF THE DRAWINGS

The teachings of the present disclosure can be readily understood by considering the following detailed description in conjunction with the accompanying drawings, in which:

FIG. 1 illustrates an example system configured to support social engineering attack prevention for a corporate network;

FIG. 2 illustrates an example process of supporting social engineering attack prevention for a corporate network;

FIG. 3 illustrates a flowchart of an example method for supporting social engineering attack prevention; and

FIG. 4 illustrates a high level block diagram of a computing system specifically programmed to perform the steps, functions, blocks and/or operations described herein.

To facilitate understanding, identical reference numerals have been used, where possible, to designate identical elements that are common to the figures.

### DETAILED DESCRIPTION

In one example, the present disclosure describes various methods, computer-readable media, and apparatuses for supporting social engineering attack prevention. The support for social engineering attack prevention may be based on early detection and remediation of social engineering attacks. The support for social engineering attack prevention may be provided for various types of social engineering attacks (e.g., corporate spear phishing attacks, customer phishing attacks, and so forth) which may be initiated within various contexts (e.g., against users of corporate networks, such as employees, customers, and so forth).

In one example, supporting social engineering attack prevention may include identifying a workflow to be protected, identifying, for the workflow, a set of valid resources of the workflow where the set of valid resources includes a set of artifacts and a set of templates, identifying, from a dataset associated with the workflow and based on the set of artifacts, a communication associated with the workflow, determining, based on an analysis of the communication based on the set of templates, that the communication is malicious, and initiating, based on the determination that the communication is malicious, a remediation action. In one example, a template of a workflow may be a resource which may be presented to a user (e.g., aurally, visually, or the like) within the context of a workflow, which an attacker may try to replicate as part of an attack (e.g., in order to fool a user into believing that the user is interacting with a real entity within the context of the workflow). In one example, an artifact of a workflow may be an element of or associated with a workflow (which may or may not be presented to the user) which an attacker may try to replicate as part of an attack (e.g., in order to fool a user into believing that the user is interacting with a real entity within the context of the workflow).

In one example, a method includes using a processing system for identifying a workflow to be protected, identifying, for the workflow, a set of valid resources of the workflow where the set of valid resources includes a set of artifacts and a set of templates, identifying, from a dataset associated with the workflow and based on the set of artifacts, a communication associated with the workflow, determining, based on an analysis of the communication based on the set of templates, that the communication is malicious, and initiating, based on the determination that the communication is malicious, a remediation action.

In one example, an apparatus includes a processing system including at least one processor and a computer-readable medium storing instructions which, when executed by the processing system, cause the processing system to perform operations that include identifying a workflow to be protected, identifying, for the workflow, a set of valid resources of the workflow, wherein the set of valid resources includes a set of artifacts and a set of templates, identifying, from a dataset associated with the workflow and based on the set of artifacts, a communication associated with the workflow, determining, based on an analysis of the communication based on the set of templates, that the communication is malicious, and initiating, based on the determination that the communication is malicious, a remediation action.

In one example, a non-transitory computer-readable medium stores instructions which, when executed by a processing system including at least one processor, cause the processing system to perform operations that include identifying a workflow to be protected, identifying, for the workflow, a set of valid resources of the workflow, wherein the set of valid resources includes a set of artifacts and a set of templates, identifying, from a dataset associated with the workflow and based on the set of artifacts, a communication associated with the workflow, determining, based on an analysis of the communication based on the set of templates, that the communication is malicious, and initiating, based on the determination that the communication is malicious, a remediation action.

It will be appreciated that, although primarily presented herein with respect to use of social engineering attack prevention for early detection and remediation of social engineering attacks for specific types of workflows (namely, workflows based on communication interactions (e.g., emails, text messages, voice communications, videos, or the like), user interactions (e.g., use of websites, use of applications, or the like), and so forth) of a specific type of environment (namely, a corporate network) to protect specific types of entities (namely, internal and external users of a corporation and the corporate network of the corporation), various examples of social engineering attack prevention presented herein may be used for early detection and remediation of social engineering attacks for other types of workflows (e.g., based on other types of communication interactions, user interactions, or the like), for other types of environments (e.g., access networks, core networks, datacenters, or the like), to protect other types of entities (e.g., other types of users, devices, and so forth), and so forth.

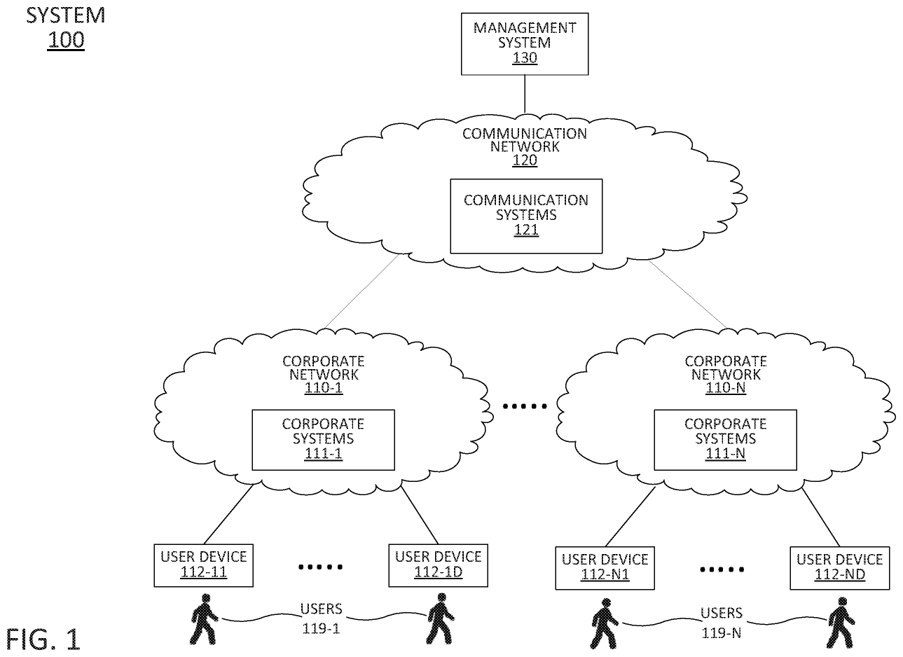

These and other aspects of the present disclosure are discussed in greater detail below in connection with the examples of FIGS. 1-4.

FIG. 1 illustrates an example system configured to support social engineering attack prevention for a corporate network.

The system 100 includes a set of corporate networks 110-1-110-N (collectively, corporate networks 110), a communication network 120 configured to support communications of the corporate networks 110, and a management system 130 configured to support management functions for the communication network 120 supporting the corporate networks 110.

The corporate networks 110 include corporate systems 111 configured to support communications of sets of end user devices 112 of sets of users 119, respectively (illustratively, corporate network 110-1 includes corporate systems 111-1 configured to support communications of a set of end user devices 112-11-112-1D for a set of users 119-1 of corporate network 110-1, corporate network 110-N includes corporate systems 111-N configured to support communications of a set of end user devices 112-N1-112-ND for a set of users 119-N of corporate network 110-N, with other corporate networks 110 being omitted for purposes of clarity).

The corporate systems 111 of the corporate networks 110 may include various types of systems which may support communications of the users 119 using the end user devices 112 associated with the corporate networks 110. For example, the corporate systems 111 of the corporate networks 110 may include network elements (e.g., routers, switches, hubs, or the like), servers configured to support various applications which may be accessible to the users 119 via the end user devices 112 (e.g., email servers, text message servers, voice communication servers, web servers, application servers, or the like), security systems configured to provide security within the corporate networks 110 (e.g., security devices such as firewalls and proxy servers, security systems configured to support detection of malicious activity targeted against the corporate networks 110 or users 119 of the corporate networks 110, security systems configured to support remediation actions in response to malicious activity targeted against the corporate networks 110 or users 119 of the corporate networks 110, or the like), and so forth.

The end user devices 112 associated with the corporate networks 110 may include any types of devices which may be used by the users 119 of the corporate network 110 for interacting with the workflows supported by the corporate networks 110. For example, the end user devices 112 may include desktop computers, laptop computers, tablets, smartphones, workstations, and so forth. The users 119 of the corporate networks 110 may include internal users of the corporate networks 110 (e.g., employees of the corporations operating the corporate networks 110), external users of the corporate networks 110 (e.g., customers of the corporations operating the corporate networks 110), and so forth. It will be appreciated that, although the end user devices 112 are depicted as being located outside of the corporate networks 110 in order to illustrate an association of the end user devices 112 with the corporate networks 110 and a capability of the end user devices 112 to communicate via the corporate networks 110, various end user devices 112 may be considered to be located within the corporate networks 110 (e.g., where the users 119 are employees of the corporation), various end user devices 112 may be considered to be located outside of the corporate networks 110 (e.g., where the users 119 are employees of the corporation, customers of the corporation, and the like), and so forth.

The corporate networks 110 may be configured to support various types of workflows for the users 119 which the users 119 may access and participate in via the end user devices 112. The workflows of the users 119 may have various objectives which may be achieved in various ways based on various types of interactions. The workflows for the users 119 may be based on interactions such as communication interactions (e.g., emails, text messages, voice calls, videos, or the like, which also may be referred to more generally as communications) which may include receiving communications and sending communications, user interactions (e.g., website interactions, application interactions, or the like, at least some of which may be based on communications (e.g., a request to access a web page, a response with a web page to be rendered, a request to access an application, a response with an application user interface to be rendered, or the like)), and so forth. It will be appreciated that at least some of the information used or produced within the context of a workflow also may be considered to be content of the workflow (e.g., text messages, audio clips, video clips, multimedia clips, and so forth). It will be appreciated that the workflows supported for users 119, and the manner in which the workflows are supported for users 119, may vary across different types of users 119.

For example, where the users 119 of a corporate network 110 are internal users of the corporate network 110, workflows may include employee onboarding workflows, customer support workflows, request and approval workflows, employee management workflows, and so forth. For example, where the users 119 are internal users of the corporate network 110, workflows may include interactions such as receipt of an email or text message including a request that the user respond with information (e.g., respond with personal information to be maintained by human resources, respond with confidential corporate information, or the like), receipt of a phone call including a request that the user respond with information by pressing certain keys (e.g., respond with personal information to be maintained by human resources, respond with confidential corporate information, or the like), receipt of an email or text message including a link to a website to be accessed (e.g., where the user then clicks the link to log in to a corporate employee portal, to access a performance review, or the like), receipt of a voice message including a telephone number to call (e.g., where the employee then calls the telephone number to contact human resources to provide updated information, to receive a security code for corporate portal login, and so forth), receipt of a video with a link to an employee application to be accessed, initiation of a request to access a website (e.g., a corporate employee portal, a corporate financial system, or the like), and so forth.

For example, where the users 119 of a corporate network 110 are external users of the corporate network 110, workflows may include customer onboarding workflows, customer service workflows, customer support workflows, and so forth. For example, where the users 119 are external users of the corporate network 110, workflows may include interactions such as receipt of an email or text message including a request that the user respond with information (e.g., respond with personal information to be maintained by the corporation, respond with account information to be maintained by the corporation, or the like), receipt of a phone call including a request that the user respond with information by pressing certain keys (e.g., respond with personal information to be maintained by the corporation, respond with account information to be maintained by the corporation, or the like), receipt of an email or text message including a link to a website to be accessed (e.g., where the user then clicks the link to log in to a customer portal to perform account management functions, to request modifications to their service, or the like), receipt of a voice message including a telephone number to call (e.g., where the customer then calls the telephone number to contact the company to provide updated information, to receive a security code for accessing a service of the corporation subscribed to by the customer, and so forth), receipt of a video with a link to a customer application to be accessed, initiation of a request to access a website (e.g., a customer service portal, a customer account management system, or the like), and so forth.

It will be appreciated that various other types of workflows may be supported, various workflows may be supported based on various other types of interactions (e.g., communication interactions, user interactions, and the like), various workflows may be supported based on various other combinations of interactions (e.g., communication interactions, user interactions, and the like), workflows may be supported based on various other communications, interactions, activities, actions, and so forth.

The communication network 120 supports communications of the corporate networks 110 and, thus, various types of interactions of users 119 of the corporate networks 110 within the context of various types of workflows which may be supported by the corporate networks 110 for the users 119 of the corporate networks 110.

The communication network 120 may include any one or more types of communication networks which may support communications of the corporate networks 110. For example, the communication network 120 may include a traditional circuit switched network (e.g., a public switched telephone network (PSTN)). For example, the communication network 120 may include a packet network, such as an Internet Protocol (IP) network (e.g., a Voice over IP (VoIP) network, a Service over IP (SoIP) network, an IP Multimedia Subsystem (IMS) network, or the like), an asynchronous transfer mode (ATM) network, a wireless network (e.g., a cellular network such as a 2G network, a 3G network, a 4G network, a long term evolution (LTE) network, a 5G network, or the like), and so forth. It will be appreciated that the communication network 120 may include one or more access networks, one or more core networks, and so forth.

The communication network 120 includes communication systems 121 configured to support communications of corporate networks 110 and, thus, configured to support various types of workflows which may be supported by the corporate networks 110 for the users 119 of the corporate networks 110. For example, the communication systems 121 may include network elements (e.g., access devices (e.g., base transceiver stations (BTSs), WiFi access points (APs), and so forth), routers, switches, hubs, and so forth), virtualization infrastructure configured to support network function virtualization (NFV) based on virtualized network functions (VNFs), servers configured to support various applications (e.g., email servers, text message servers, VoIP servers, video servers, web servers, application servers, or the like), security systems configured to provide security within the communication network 120 for the corporate networks 110 (e.g., security devices such as firewalls and proxy servers, security systems configured to support detection of malicious activity targeted against the corporate networks 110 or users 119 of the corporate networks 110, security systems configured to support remediation actions in response to malicious activity targeted against the corporate networks 110 or users 119 of the corporate networks 110, or the like), and so forth.

The management system 130 may be configured to support various management functions for supporting management of communication network 120. For example, the management system 130 may support network provisioning functions, service provisioning functions, network monitoring functions, network security functions, and so forth. It will be appreciated that the management system 130 also may support various management functions for supporting management of corporate networks 110.

The system 100, as discussed herein, may be configured to support social engineering attack prevention for supporting early detection of social engineering attacks attempted against the users 119 of the corporate networks 110. The system 100 may be configured to support social engineering attack prevention for protecting one or more workflows supported by a corporate network 110 and, thus, for protecting the users 119 of the corporate network 110, protecting the corporate network 110, and so forth. The system 100 may be configured to support social engineering attack prevention for one or more workflows supported by a corporate network 110 by applying social engineering attack prevention in various ways (e.g., using centralized or distributed approaches, using deployment at various network locations, and so forth). For example, social engineering attack prevention may be applied within a corporate network 110 for protecting the corporate network 110 (e.g., on corporate systems 111, on other systems or devices within the corporate networks 110, or the like) and preventing malicious attacks from reaching certain portions of the corporate network 110 (e.g., certain corporate systems 111, end user devices 112, or the like) or entities which utilize the corporate network 110 (e.g., users 119), within the communication network 120 for protecting one or more of the corporate networks 110 (e.g., on communication systems 121, on other systems or devices within the communication network 120, or the like) for preventing malicious attacks from reaching the one or more corporate networks 110, and so forth. It will be appreciated that application of social engineering attack prevention for protecting a workflow may be based on the type of network for which social engineering attack prevention is applied, the type of network within which social engineering attack prevention is applied, the type of workflow for which social engineering attack prevention is applied, and so forth. It will be appreciated that social engineering attack prevention may be applied in various other ways for supporting early detection of social engineering attacks attempted against the users 119 of the corporate networks 110.

The system 100, as discussed herein, may be configured to support social engineering attack prevention for a workflow supported by a corporate network 110 (e.g., for protecting a user 119 of the corporate network 110 that interacts with that workflow via the end user device 112 of the user 119, for protecting the corporate network 110, and so forth). In one example, supporting social engineering attack prevention for a workflow supported by a corporate network 110 may include identifying the workflow to be protected, obtaining a set of valid resources of the workflow (e.g., a set of one or more templates of the workflow, a set of one or more artifacts of the workflow, and so forth), identifying a communication of the workflow based on the set of valid resources of the workflow (e.g., based on a set of one or more filters created based on the set of one or more artifacts), determining that the communication is a malicious communication based on an analysis of the communication of the workflow based on the set of valid resources of the workflow (e.g., based on the set of one or more templates of the workflow), and initiating one or more remediation actions based on the malicious communication. It will be appreciated that the various functions discussed above as being performed for supporting social engineering attack prevention for a workflow supported by a corporate network 110 may be performed in a centralized manner or a distributed manner by various elements of the system 100.

The application of social engineering attack prevention for the workflow supported by the corporate network 110, as indicated above, may include identifying the workflow to be protected. It will be appreciated that the identification of the workflow to be protected also may be considered to be an identification of a workflow for which social engineering attack prevention is to be applied for providing protection against attacks.

In one example, the identification of the workflow to be protected may be based on detection of a request to provide protection (e.g., a request to protect the workflow, a request to protect certain users or certain groups of users that use the workflow, and so forth). For example, the request to protect the workflow may be a request of a user (e.g., a user 119, a security agent of the company that operates the corporate network 110, or the like), a request of a device (e.g., a corporate system 111 of the corporate network 110, a communication system 121 of the communication network 120, or the like), a request of an entity (e.g., an entity of or associated with the corporate network 110, an entity of or associated with the communication network 120, or the like), and so forth.

In one example, the identification of the workflow to be protected may be based on a detection of a potential security event associated with the workflow. For example, use of social engineering attack prevention for an email-based workflow may be activated based on an identification of an email phishing attempt, use of social engineering attack prevention for a text message based workflow may be activated based on an identification of a text phishing attempt, use of social engineering attack prevention for a workflow that is based on sending of an email with a link to a website may be activated based on an identification of a phishing website designed to mimic a valid corporate website, and so forth. It will be appreciated that the workflow to be protected may be identified based on detection of various other types of potential security events associated with the workflow.

In one example, the identification of the workflow to be protected may be based on identification of a group of users to be protected and an associated determination that the users in the group of users have access to the workflow, use the workflow, and so forth. It will be appreciated that this may include identification of employees of the corporation that are likely to be targeted, identification of customers of the corporation that are likely to be targeted, and so forth.

The identification of the group of users to be protected, for internal users of corporate network 110 (e.g., employees of the corporation), may be based on corporate credentials of the users, divisions of the company in which the users work, applications to which the users have access, and so forth. For example, the group of users may be a subset of employees of the corporation with access to an application that could be abused by a bad actor to achieve some goal. The identification of the group of users may be based on categorization of users (e.g., based on various characteristics as discussed above, such as corporate credentials, corporate title, corporate location, applications and resources to which the users have access, and so forth) to allow for the identification of the workflows with which the users typically interact and which attackers could replicate to gain the trust of the users and execute attacks.

The identification of the group of users to be protected, for external users of corporate network 110 (e.g., customers of the corporation), may be based on service plans of the users, user profiles of the users, websites to which the users have access or which the users have used in the past or are likely to use, applications to which the users have access or which the users have used in the past or are likely to use, and so forth. For example, the group of users may be a subset of customers of the corporation which have used or are likely to use an application that could be abused by a bad actor to achieve some goal. The identification of the group of users may be based on categorization of users (e.g., based on various characteristics as discussed above, such as service plans, user profiles, applications and resources to which the users have access or which the users have used in the past or are likely to use, and so forth) to allow for the identification of the workflows with which the users typically interact and which attackers could replicate to gain the trust of the users and execute attacks.

It will be appreciated that the identification of the workflow to be protected may be performed in various other ways.

The application of social engineering attack prevention for the workflow supported by the corporate network 110, as indicated above, may include obtaining a set of valid resources of the workflow.

The set of valid resources of the workflow may include various types of resources which may be used to provide the workflow, which may be sourced from various sources of such resources which may be used to provide the workflow. For example, the set of valid resources of the workflow may include resources which may be used within the context of the workflow (e.g., templates, artifacts, and so forth), underlying resources which may be used to support the workflow (e.g., corporate domains, corporate URLs, and so forth), resources which may be associated with the workflow, and so forth. For example, the set of valid resources of the workflow may be sourced from various types of valid aspects of the workflow. For example, the set of valid resources of the workflow may be sourced from valid communications of the workflow (e.g., valid email templates and content, valid text message templates and content, valid voice communication templates and content, valid video call templates and content, and so forth). For example, the set of valid resources of the workflow may be sourced from valid websites which may be used within the context of the workflow (e.g. source URLs, web page formats, web page content, and so forth). For example, the set of valid resources of the workflow may be sourced from valid applications which may be used within the context of the workflow (e.g. source URLs, application user interface formats, application content, and so forth). For example, the set of valid resources of the workflow may be sourced from sources of underlying resources which may be used to support the workflow, sources of resources which may be associated with the workflow, and so forth. The obtaining of the set of valid resources of the workflow is discussed further below. It will be appreciated that the set of valid resources for a workflow may depend on the workflow type of the workflow.

The set of valid resources of the workflow, as indicated above, may include a set of one or more templates of the workflow. In general, a template of a workflow may be a resource which may be presented to a user (e.g., aurally, visually, or the like) within the context of a workflow, which an attacker may try to replicate as part of an attack (e.g., in order to fool a user into believing that the user is interacting with the corporation within the context of the workflow). For example, the set of one or more templates of the workflow may include one or more email templates for one or more types of emails which may be sent within the workflow, one or more text message templates for one or more types of text messages which may be sent within the workflow, one or more voice call templates for one or more types of voice calls which may be performed within the workflow, one or more web page templates for one or more web pages which may be accessed within the workflow, one or more application templates for one or more types of applications which may be accessed within the workflow, and so forth. It will be appreciated that various combinations of such templates may be included within the set of templates of the workflow where multiple template types are used within the workflow (e.g., an email template and a web page template where the workflow involves sending of an email including a URL to a web page, a text message template and a voice call template where the workflow involves sending of a text message including a phone number to be used to initiate a voice call, and so forth). It will be appreciated that the set of one or more templates of the workflow may include various other types of templates which may be used within various other types of workflows, that one or more templates in the set of one or more templates of the workflow may be obtained from various other sources of such artifacts, and so forth. It will be appreciated that various aspects of templates may be used within the context of social engineering attack prevention for detecting attacks, such as overall formatting of the templates (e.g., the “look and feel” of communications and interfaces (e.g., arrangements of information, color schemes, or the like), arrangements of content, or the like), source information included within the templates (e.g., email addresses, phone numbers, mailing addresses, or the like), formatting of source information included within the templates (e.g., formats of source identifiers, IP addresses, corporate domain structures, URL structures, or the like), content included within the templates (e.g., words, phrases, sentences, sounds, audio clips, images, videos, or the like), formatting of content included within the templates (e.g., formats of text-based content, formats of audio-based content, or the like), and so forth.

The set of valid resources of the workflow, as indicated above, may include a set of one or more artifacts of the workflow. In general, an artifact of a workflow may be an element of or associated with a workflow (which may or may not be presented to the user) which an attacker may try to replicate as part of an attack (e.g., in order to fool a user into believing that the user is interacting with the corporation within the context of the workflow). For example, the one or more artifacts of the workflow may include source information (e.g., email addresses, phone numbers, IP addresses, mailing addresses, or the like), content (e.g., words, phrases, sentences, sounds, audio clips, images, videos, and so forth), and so forth. The set of one or more artifacts of the workflow may be obtained from the set of templates of the workflow (e.g., from one or more communication templates (e.g., email, text, voice, video, and so forth), from one or more web page templates, from one or more application templates, and so forth), since such templates typically include such artifacts that the attackers attempt to replicate in attacks (e.g., in any media presented to users, such as communications (e.g., email, text, voice, video, or the like), user interfaces (e.g., web pages, applications, or the like), and so forth). It will be appreciated that the set of one or more artifacts of the workflow may include various other types of artifacts which may be used within various other types of workflows, that one or more artifacts in the set of one or more artifacts of the workflow may be obtained from various other sources of such artifacts, and so forth. It will be appreciated that various artifacts may be used within the context of social engineering attack prevention for detecting attacks.

It will be appreciated that the set of valid resources of the workflow (e.g., templates, artifacts, or the like) may vary for different types of workflows, different types of interactions (e.g., communications, use of web pages, use of applications, and so forth) which may be performed within different workflows, and so forth. It is noted that examples of templates and artifacts for different types of interactions (e.g., communications, user interface interactions within the context of web pages or applications, and so forth) which may be performed within different workflows follow.

For example, for a workflow including sending of an email, the templates and artifacts may include various templates and artifacts associated with sending of the email. For example, the set of valid templates may include one or more templates for one or more email formats used by the corporation for communicating with users such as employees or customers. For example, for employees, the one or more templates may include a standard email used by the corporation for requesting information from the user, a standard email used by the corporation for requesting that the user update a password for the corporate portal accessed by the user or one or more corporate applications accessed by the user, a standard email used by the corporation for requesting that the user access an internal corporate web page for performing a function, and so forth. For example, for customers, the one or more templates may include a standard email used by the corporation for thanking the customer for being a customer, a standard email used by the corporation for requesting that the customer log in to a website of the corporation to update personal information or account information, a standard email used by the corporation for informing the customer that a monthly statement is available and may be accessed via a web page, and so forth. For example, the artifacts may include elements typically included within or associated with emails which may be targeted to users such as employees or customers of the corporation (e.g., a valid source email address, a valid mailing address of the corporation, a valid icon or image (e.g., a logo of the corporation), a valid sentence or sentences used by the corporation, a valid IP address where an IP address is included within the email, a valid corporate domain structure where a corporate domain is included within the email, a valid URL structure where a URL is included within the email, and so forth).

For example, for a workflow including sending of a text message, the templates and artifacts may include various templates and artifacts associated with sending of the text message. For example, the set of valid templates may include one or more templates for one or more text message formats used by the corporation for communicating with users such as employees or customers. For example, for employees, the one or more templates may include a standard text message used by the corporation for requesting information from the user, a standard text message used by the corporation for requesting that the user update a password for the corporate portal accessed by the user or one or more corporate applications accessed by the user, a standard text message used by the corporation for requesting that the user access an internal corporate web page for performing a function, and so forth. For example, for customers, the one or more templates may include a standard text message used by the corporation for thanking the customer for being a customer, a standard text message used by the corporation for requesting that the customer log in to a website of the corporation to update personal information or account information, a standard text message used by the corporation for informing the customer that a monthly statement is available and may be accessed via a web page, and so forth. For example, the artifacts may include elements typically included within or associated with text messages which may be targeted to users such as employees or customers of the corporation (e.g., a valid source phone number, a valid sentence or sentences used by the corporation, a valid IP address where an IP address is included within the text message, a valid corporate domain structure where a corporate domain is included within the text message, a valid URL structure where a URL is included within the text message, and so forth).

For example, for a workflow including sending of a voice communication, the templates and artifacts may include various templates and artifacts associated with sending of the voice communication. For example, the set of valid templates may include one or more templates for one or more voice communication formats used by the corporation for communicating with users such as employees or customers. For example, for employees, the one or more templates may include a standard voice communication used by the corporation for requesting information from the user, a standard voice communication used by the corporation for requesting that the user update a password for the corporate portal accessed by the user or one or more corporate applications accessed by the user, a standard voice communication used by the corporation for requesting that the user access an internal corporate web page for performing a function, and so forth. For example, for customers, the one or more templates may include a standard voice communication used by the corporation for thanking the customer for being a customer, a standard voice communication used by the corporation for requesting that the customer log in to a website of the corporation to update personal information or account information, a standard voice communication used by the corporation for informing the customer that a monthly statement is available and may be accessed via a web page, and so forth. For example, the artifacts may include elements typically included within or associated with voice communications which may be targeted to users such as employees or customers of the corporation (e.g., a valid phone number, a valid sound of the corporation, a valid statement or statements used by the corporation, a valid IP address where an IP address is included within the voice communication, a valid corporate domain structure where a corporate domain structure is included within the voice communication, a valid URL structure where a URL is included within the voice communication, and so forth).

For example, for a workflow including sending of a video, the templates and artifacts may include various templates and artifacts associated with sending of the video. For example, the set of valid templates may include one or more templates for one or more video formats used by the corporation for communicating with users such as employees or customers. For example, for employees, the one or more templates may include a standard video used by the corporation for instructing the users regarding access to various corporate resources (e.g., employee portals, employee systems, and the like), a standard video used by the corporation for requesting that the user update a password for the corporate portal accessed by the user or one or more corporate applications accessed by the user, a standard video used by the corporation for requesting that the user access an internal corporate web page for performing a function, and so forth. For example, for customers, the one or more templates may include a standard video used by the corporation for thanking the customer for being a customer, a video communication used by the corporation for requesting that the customer log in to a website of the corporation to update personal information or account information, a standard video used by the corporation for informing the customer that a monthly statement is available and may be accessed via a web page, and so forth. For example, the artifacts may include elements typically included within or associated with videos which may be targeted to users such as employees or customers of the corporation (e.g., a valid icon of the corporation, a valid sound of the corporation, a valid statement or statements used by the corporation, a valid corporate domain structure where a corporate domain structure is associated with the video, a valid URL structure where a URL is associated with the video, and so forth).

For example, for a workflow including use of a website via interaction with a web page, the templates and artifacts may include various templates and artifacts which may be included within the web page. For example, the set of valid templates may include one or more templates for one or more website formats (e.g., web portal interfaces, web pages, and so forth) used by the corporation for enabling users such as employees or customers to perform various functions. For example, for employees, the one or more templates may include a standard web portal via which the user may access an internal website of the corporation (e.g., a corporate portal, a portal to a specific application, or the like), one or more web pages of an internal website of the corporation (e.g., a page via which the user may maintain a schedule, a page on which the user may perform timekeeping functions, or the like), and so forth. For example, for customers, the one or more templates may include a standard web portal via which the user may access a website of the corporation (e.g., a corporate portal, a portal to a specific application, or the like), one or more web pages of a website of the corporation (e.g., a page via which the user may access an account, a page on which the user may pay a bill, or the like), and so forth. For example, the artifacts may include elements typically included within or associated with web pages which may be targeted to users such as employees or customers of the corporation (e.g., a valid corporate domain structure for the website, a valid URL structure for the website, valid content which may be included on the website (e.g., text, audio, or the like) and so forth).

For example, for a workflow including use of an application via interaction with a user interface of the application, the templates and artifacts may include various templates and artifacts which may be included within the user interface of the application. For example, the set of valid templates may include one or more templates for one or more application formats used by the corporation for enabling users such as employees or customers to perform various functions. For example, for employees, the one or more templates may include one or more application pages or interfaces of a standard application via which the user may access an internal website of the corporation (e.g., a corporate portal, a portal to a specific application, or the like), one or more application pages or interfaces of a standard application via which the user may perform one or more actions (e.g., a scheduling application via which the user may maintain a schedule, a time keeping application via which the user may perform timekeeping functions, or the like), and so forth. For example, for customers, the one or more templates may include one or more application pages or interfaces of a standard application via which the user may access a website of the corporation (e.g., a corporate portal, a portal to a specific application, or the like), a standard application via which the user may perform one or more actions (e.g., an application via which the user may access an account, an application via which the user may pay a bill, or the like), and so forth. For example, the artifacts may include elements typically included within or associated with applications (e.g., application pages, interfaces, or the like) which may be targeted to users such as employees or customers of the corporation (e.g., a valid corporate domain structure for the application, a valid URL structure for the application, valid content which may be included within the application (e.g., text, audio, or the like) and so forth).

The set of valid resources of the workflow, as indicated above, may include various other types of resources which may be used within the context of social engineering attack prevention for detecting attacks (e.g., underlying resources which may be used to support the workflow (e.g., corporate domains, corporate URLs, and so forth), resources which may be associated with the workflow, and so forth). It will be appreciated that such resources may or may not be included within templates (e.g., depending on the type of element, the workflow, and so forth), may or may not be considered to be artifacts (e.g., depending on the type of element, the workflow, and so forth), and so forth.

The set of valid resources for the workflow to be protected may be obtained in various ways. For example, the set of valid resources for the workflow may be obtained from one or more databases of valid resources, from one or more systems involved in supporting the workflow, by analyzing the workflow to generate the set of valid resources for the workflow, and so forth. It will be appreciated that the set of valid resources for the workflow may be obtained in various other ways.

It will be appreciated that the obtaining of the set of valid resources for the workflow may be performed in various other ways.

The application of social engineering attack prevention for the workflow supported by the corporate network 110, as indicated above, may include identifying a communication of the workflow. The communication of the workflow that is identified may be a potentially malicious communication of the workflow that is to be further analyzed for verifying that the potentially malicious communication of the workflow is in fact malicious before remediation actions are initiated.

The communication of the workflow that is identified may be identified from a workflow dataset associated with the workflow. The workflow dataset of the workflow may include legitimate data of the workflow associated with legitimate interactions of the workflow and malicious data of the workflow associated with malicious interactions of the workflow. The workflow dataset of the workflow may include various types of data produced within the context of the workflow, or otherwise associated with the workflow, which may be monitored and analyzed for identifying and preventing malicious communications. The workflow dataset of the workflow may include communications interactions (e.g., a set of communications of the workflow), indications of user interactions (e.g., communications associated with various user interactions, web pages or application interfaces used in various user interactions), content, events, metadata, and so forth. For example, the workflow dataset of the workflow may include emails where the workflow includes email communications, text messages where the workflow includes text message communications, voice calls where the workflow includes voice call communications, videos where the workflow includes video communications, requests for web pages and responses with web pages where the workflow includes interaction with web pages, requests for applications user interfaces and responses with application user interfaces where the workflow includes interaction with applications, and so forth. It will be appreciated that the workflow dataset of the workflow may include various other types of data (e.g., various other types of communications interactions, indications of user interactions, content, metadata, and the like) which may be analyzed to detect and prevent social engineering attacks.

The communication of the workflow that is identified may be identified based on analysis of the workflow dataset of the workflow using the set of valid resources of the workflow (e.g., based on the set of artifacts of the workflow). The communication of the workflow that is identified may be identified based on application of a set of filters to the workflow dataset of the workflow, where the set of filters is configured to enable identification of potentially malicious communications from a set of communications that includes both legitimate communications of the workflow and malicious communications of the workflow. The set of filters that is applied for identifying the communication of the workflow may be created based on the set of valid resources of the workflow (e.g., based on the set of artifacts of the workflow). The filtering of the workflow dataset of the workflow for identifying potentially malicious communications which could be attacks may include identifying any workflow data associated with potentially malicious communications for the workflow (e.g., workflow data that does not exactly or at least sufficiently match the artifacts of the workflow), removing any workflow data associated with known legitimate communications for the workflow (e.g., workflow data that exactly or at least sufficiently matches the artifacts of the workflow), and so forth.

For example, for a workflow that is based on sending of an email, the set of filters that is applied to identify potentially malicious emails from the full set of emails included in the dataset of the workflow may include a set of valid source email addresses that should be included in any legitimate emails, a set of key words or phrases that might be present in a malicious email (e.g., determined based on email artifacts identified from email templates for the workflow), and so forth.

For example, for a workflow that is based on sending of a text message, the set of filters that is applied to identify potentially malicious text messages from the full set of text messages included in the dataset of the workflow may include a set of valid source phone numbers that should be included in any legitimate text messages, a set of key words or phrases that might be present in a malicious text message (e.g., determined based on text message artifacts identified from text message templates for the workflow), and so forth.

For example, for a workflow that is based on sending of a voice communication, the set of filters that is applied to identify potentially malicious voice communications from the full set of voice communications included in the dataset of the workflow may include a set of valid source phone numbers that should be associated with any legitimate voice communications, a set of key words or phrases that might be present in a malicious voice communication (e.g., determined based on voice communication artifacts identified from voice communication templates for the workflow), and so forth.

For example, for a web page, the set of filters that is applied to identify a potentially malicious communication associated with the web page (e.g., a request to access the web page, a response including web page information which may be rendered, and so forth) from the full set of communications included in the dataset of the workflow may include a set of valid source URLs that should be associated with any legitimate web pages, a set of key words or phrases that might be present in a malicious web page (e.g., determined based on web page artifacts identified from web page templates for the workflow), a set of valid images that should be associated with any legitimate web page, and so forth.

For example, for an application, the set of filters that is applied to identify a potentially malicious communication associated with the application (e.g., a request to access the application, a response including application information which may be rendered, and so forth) from the full set of communications included in the dataset of the workflow may include a set of valid source URLs that should be associated with any legitimate applications, a set of key words or phrases that might be present in a malicious communication for the application (e.g., determined based on application artifacts identified from application templates for the workflow), a set of valid images that should be associated with any legitimate application, and so forth.

The communication of the workflow that is identified may be identified based on collection of information (e.g., events, metadata, and so forth) from a set of communications of the workflow. The communication of the workflow that is identified from the set of communications of the workflow may be identified based on collection of information from the set of communications of the workflow based on application of a set of filters created for the workflow from artifacts associated with the workflow. The filtering of datasets associated with the workflow for identifying potentially malicious communications which could be attacks may include removing any metadata associated with known legitimate communications for the workflow (e.g., metadata that exactly or at least sufficiently matches the artifacts of the workflow). For example, if looking for suspicious URLs in proxy data, a dictionary of URL structures associated with real corporate websites coming from unfamiliar sources may be used as a filter for identifying potentially malicious communications. It will be appreciated that the various examples provided above for applying the set of filters to identify potentially malicious communications of the workflow also may be utilized within this context of collection of information such as events and metadata in order to identify potentially malicious communications of the workflow.

It will be appreciated that the identification of the communication of the workflow, for further analysis to determine whether the communication of the workflow is a malicious communication, may be performed in various other ways.

The application of social engineering attack prevention for the workflow supported by the corporate network 110, as indicated above, may include determining that the communication is a malicious communication based on an analysis of the communication of the workflow based on the set of valid resources of the workflow.

The determination that the communication is a malicious communication associated with an attack, as opposed to a legitimate communication that is not associated with an attack, is based on an analysis of the communication of the workflow. The analysis of the communication of the workflow may be based on the set of valid resources of the workflow. The analysis of the communication of the workflow may be based on the set of one or more templates of the workflow. The analysis of the communication of the workflow may be based on the set of one or more artifacts of the workflow. The analysis of the communication of the workflow may be based on comparisons of the communication of the workflow to the set of valid resources of the workflow (e.g., to one or more templates, one or more artifacts, or the like). The communication of the workflow may be determined to be malicious based on a determination that the communication of the workflow and the valid resources of the workflow are similar or substantially similar (e.g., given the assumption that the attackers are trying to gain user confidence on the social engineered entities, the adversary entities are likely to be similar to the legitimate entities).

The analysis of the communication of the workflow, based on comparisons of the communication of the workflow to the set of valid resources of the workflow, may be performed by analyzing various aspects of the communication of the workflow and the set of valid resources of the workflow using various types of analysis. For example, the analysis of the communication of the workflow in view of the valid resources of the workflow may include comparisons for identifying similar formatting (e.g., overall “look and feel”, arrangement of information, color schemes, specific content included, and so forth), for identifying similar source information (e.g., domain analysis for emails and text messages, URL analysis for web pages and applications, and so forth), for identifying similar content (e.g., a phrase or logo in an email, a word or phrase in a text message, a statement or sound in a voice communication, an image on a web page, and so forth), and so forth. It will be appreciated that the analysis that is performed may vary for different types of communications which may be analyzed when evaluating the communication of the workflow for determining whether the communication of the workflow is malicious.

For example, where the communication includes sending of an email including a URL to a web page, the analysis of the communication to determine whether the communication is malicious may include analyzing the formatting of the email to determine whether it is similar to a valid email template, analyzing specific content included within the email to determine whether it is similar to content included within a valid email template, analyzing a structure of the URL included within the email, accessing a web page pointed to by the URL and analyzing the web page to determine whether it is similar to a valid web page template (e.g., based on one or more of formatting of the web page, content included within the web page, and so forth), and so forth.

For example, where the communication includes sending of a text message including a URL to a web page, the analysis of the communication to determine whether the communication is malicious may include analyzing the formatting of the text message to determine whether it is similar to a valid text message template, analyzing specific content included within the text message to determine whether it is similar to content included within a valid text message template, analyzing a structure of the URL included within the text message, accessing a web page pointed to by the URL and analyzing the web page to determine whether it is similar to a valid web page template (e.g., based on one or more of formatting of the web page, content included within the web page, and so forth), and so forth.

For example, where the communication includes sending of a voice communication including a telephone number to be called, the analysis of the communication to determine whether the communication is malicious may include analyzing the formatting of the voice communication to determine whether it is similar to a valid voice communication template, analyzing specific content included within the voice communication to determine whether it is similar to content included within a valid voice communication template, analyzing the phone number included within the voice communication to determine whether it is a valid phone number, and so forth.

For example, where the communication includes sending of a video, the analysis of the communication to determine whether the communication is malicious may include analyzing the formatting of the video to determine whether it is similar to a valid video template, analyzing specific content included within the video to determine whether it is similar to content included within a valid video template, analyzing a structure of the URL associated with the video, and so forth.

For example, where the communication is a communication associated with access by a user to a web page (e.g., sending a request for the web page, receiving a response with the web page, and so forth), the analysis of the communication to determine whether the communication is malicious may include analyzing specific content included within the communication to determine whether it is similar to content included within a valid communication to access the associated valid web page, analyzing a structure of the URL included within the communication for the web page, accessing the web page pointed to by the URL and analyzing the web page to determine whether it is similar to a valid web page template (e.g., based on one or more of formatting of the web page, content included within the web page, and so forth), and so forth.

For example, where the communication is a communication associated with access by a user to an application (e.g., sending a request associated with the application, receiving a response associated with the application, and so forth), the analysis of the communication to determine whether the communication is malicious may include analyzing specific content included within the communication to determine whether it is similar to content included within a valid communication to access the associated valid application, analyzing a structure of the URL included within the communication for the application, accessing the user interface of the application pointed to by the URL and analyzing the user interface of the application to determine whether it is similar to a valid application template (e.g., based on one or more of formatting of the web page, content included within the web page, and so forth), and so forth.

The analysis of the communication of the workflow may be performed using one or more learning algorithms. The analysis of the communication of the workflow using one or more learning algorithms may include using the one or more learning algorithms for performing comparisons of the communication of the workflow to the set of valid resources of the workflow. The one or more learning algorithms may include one or more machine learning (ML) algorithms, one or more deep learning (DL) algorithms, or the like. The one or more learning algorithms may be configured to support comparisons for different types of data, based on use of various types of models, and so forth. The one or more learning algorithms may be applied to measure similarity between various aspects of the communication of the workflow and various aspects of the set of valid resources of the workflow (e.g., between data of the communication of the workflow and legitimate templates, between data of the communication of the workflow and legitimate artifacts, between collected metadata of the communication of the workflow and legitimate artifacts, and so forth).

The analysis of the communication of the workflow, based on comparisons of the communication of the workflow to the set of valid resources of the workflow using one or more learning algorithms, may include extracting a set of features of the communication of the workflow, extracting a set of features of one or more of the valid resources of the workflow, and determining whether the communication of the workflow is a malicious communication based on an analysis of the set of features of the communication of the workflow and the set of features of one or more of the valid resources of the workflow. The features may include various types of features which may vary across workflow types, communication types, content types of content included within or otherwise associated with communications, and so forth. The features may be meaningful semantic features. The analysis of the set of features of the communication of the workflow and the set of features of one or more of the valid resources of the workflow may be based on a comparison of the set of features of the communication of the workflow and the set of features of one or more of the valid resources of the workflow. The analysis of the set of features of the communication of the workflow and the set of features of one or more of the valid resources of the workflow may be based on a measure of the similarity between the set of features of the communication of the workflow and the set of features of one or more of the valid resources of the workflow. The comparison of the set of features of the communication of the workflow and the set of features of one or more of the valid resources of the workflow may be based on use of one or more distance metrics (e.g., cosine, Euclidean, and so forth). The comparison of the set of features of the communication of the workflow and the set of features of one or more of the valid resources of the workflow, based on use of one or more distance metrics, may include, for each of the pairs of features extracted from the communication of the workflow and extracted from the one or more of the valid resources of the workflow, determining a distance between the features in the pair of features and using the distances between the features in the pair of features for comparing the features of the communication of the workflow and the set of features of one or more of the valid resources of the workflow. It will be appreciated that the distances between the features in the pair of features may be analyzed in various ways for determining whether the communication of the workflow is a malicious communication (e.g., based on identification of a threshold number of distances satisfying one or more distance thresholds, based on a determination of an overall distance and a determination as to whether the overall distance satisfies one or more thresholds, and so forth). The communication of the workflow may be determined to be malicious based on a determination that the set of features of the communication of the workflow and the set of features of one or more of the valid resources of the workflow are similar or substantially similar (e.g., based on relatively low distance values or distance values below a threshold or between pair of thresholds where distance metrics are used, based on other types of comparisons, or the like).

It will be appreciated that the analysis of the communication of the workflow, based on comparisons of the communication of the workflow to the set of valid resources of the workflow using one or more learning algorithms, may be performed in different ways for different types of interactions (e.g., communications, user interactions (e.g., use of web pages, use of applications, or the like), and so forth), different types of content (e.g., data, image, voice, video, and so forth) which may be associated with different types of interactions, and so forth.

In one example, where analysis of the communication of the workflow includes comparisons of text data, the comparisons of the text data may be performed using a learning algorithm that is based on a recurrent neural network (RNN). For example, where analysis of the communication of the workflow includes comparisons of text data, the comparisons of the text data may be performed using Doc2Vec, Average Word2Vec, Latent Semantic Indexing, and so forth. For example, this may be used for comparing text data which may be included in the communication of the workflow with a template from the set of templates of the workflow. For example, this may be used for comparing words, phrases, sentences, and other text data which may be included in the communication of the workflow with valid text data which may be obtained from the set of valid resources of the workflow (e.g., from one or more artifacts from the set of valid resources of the workflow, from one or more templates from the set of valid resources of the workflow, and so forth). It will be appreciated that various other algorithms, models, capabilities, and so forth may be used for processing text data within the context of comparing the communication of the workflow being analyzed to reference valid resources of the workflow.

In one example, where analysis of the communication of the workflow includes comparisons of image data, the comparisons of the image data may be performed using a learning algorithm that is based on a convolutional neural network (CNN). For example, where analysis of the communication of the workflow includes comparisons of image data, the comparisons of the image data may be performed using CNN-based feature extraction techniques, which may include object detection, segmentation, and so forth. For example, this may be used for comparing an image of a communication of the workflow with an image of a valid template which may be obtained from the set of valid resources of the workflow (e.g., an image of an email template for comparison with an image of an email of the workflow, an image of a text message template for comparison with an image of a text message of the workflow, and so forth). For example, this may be used for comparing an image of a user interface (e.g., web page, application user interface, and so forth) which may be accessed based on the communication (e.g., based on a URL or other identifier which may be included in the communication) with an image of a valid template which may be obtained from the set of valid resources of the workflow (e.g., an image of a web page template for comparison with an image of a web page which may be accessed based on the communication of the workflow, an image of an application user interface template for comparison with an image of an application user interface which may be accessed based on the communication of the workflow, and so forth). It will be appreciated that various other algorithms, models, capabilities, and so forth may be used for processing image data within the context of comparing the communication of the workflow being analyzed to reference valid resources of the workflow.

In one example, where analysis of the communication of the workflow includes comparisons of voice data, the comparisons of the voice data may be performed using a learning algorithm that is based on spectrogram-based auto-encoder embedding. For example, this may be used for comparing a voice communication of the workflow with a voice communication template from the set of templates of the workflow. For example, this may be used for comparing an audio clip from a voice communication which may be included in the communication of the workflow with valid audio data which may be obtained from the set of valid resources of the workflow (e.g., from one or more artifacts from the set of valid resources of the workflow, from one or more templates from the set of valid resources of the workflow, and so forth). It will be appreciated that various other algorithms, models, capabilities, and so forth may be used for processing voice data within the context of comparing the communication of the workflow being analyzed to reference valid resources of the workflow.

In one example, where analysis of the communication of the workflow includes comparisons of video data, the comparisons of the video data may be performed using a learning algorithm that is based on an RNN-based embedding. For example, where analysis of the communication of the workflow includes comparisons of video data, the comparisons of the image data may be performed using RNN-based feature extraction techniques, which may include object detection, segmentation, and so forth. For example, this may be used for comparing a video which may be included in the communication of the workflow with a video template from the set of templates of the workflow. For example, this may be used for comparing a video included within a communication or user interface which may be included in the communication of the workflow with valid video data which may be obtained from the set of valid resources of the workflow (e.g., from one or more artifacts from the set of valid resources of the workflow, from one or more templates from the set of valid resources of the workflow, and so forth). It will be appreciated that various other algorithms, models, capabilities, and so forth may be used for processing video data within the context of comparing the communication of the workflow being analyzed to reference valid resources of the workflow.

The analysis of the communication of the workflow, based on comparisons of the communication of the workflow (e.g., various aspects of the communication of the workflow to the set of valid resources of the workflow), may include determining a likelihood that the communication of the workflow is a malicious communication. This may include computing various scores, identifying likely true positives for malicious communications, and so forth.

The communication of the workflow, as indicated above, may be determined to be malicious based on a determination that the communication of the workflow and the valid resources of the workflow are similar or substantially similar (e.g., again, given the assumption that the attackers are trying to gain user confidence on the social engineered entities, the adversary entities are likely to be similar to the legitimate entities). It will be appreciated that communications similar to official communications of the corporation may be output for remediation, may be candidates to be output for remediation, and so forth.

It will be appreciated that the determination as to whether the communication is a malicious communication based on an analysis of the communication of the workflow based on the set of valid resources of the workflow may be performed in various other ways.

The application of social engineering attack prevention for the workflow supported by the corporate network 110, as indicated above, may include initiating one or more remediation actions based on a determination that the communication is a malicious communication.

The one or more remediation actions may depend on the workflow impacted, the type of attack (e.g., based on specifics of the malicious communication that has been detected), specifics of the attack (e.g., based on specifics of the malicious communication that has been detected), the remediation functions available (e.g., for the workflow, the type of attack, the specifics of the attack, or the like), and so forth.

The one or more remediation actions may be initiated automatically, by one or more users, and so forth.

The one or more remediation actions may include blocking the malicious communication, responding to an action initiated by the user based on the malicious communication, and so forth. For example, the one or more remediation actions may include blocking the malicious communication by preventing delivery of a communication used for the attack (e.g., preventing delivery of an email to an inbox, preventing delivery of a text message to a phone, blocking delivery of a voice communication to a phone, or the like). For example, the one or more remediation actions may include responding to an action initiated by the user based on the malicious communication by preventing access to a resource requested by the user from a communication used for the attack (e.g., preventing retrieval of a web page where a user clicked on a link in an email or a text message, preventing access to an application where the user clicked on a link in an email or text message, or the like).

The one or more remediation actions may include automatically adding a proxy block for the website and updating website categorization, automatically initiating a takedown request, automatically informing browser blocking services, automatically blocking future messages matching this attack campaign (e.g., based on one or more artifacts such as sender, verbiage (e.g., a key word or phrase), URL match, and so forth), automatically resetting user credentials of the user if the analysis was due to a URL clicked event in which the email was delivered to the user and the user clicked the URL (here, for safety purposes, it is assumed the user entered his or her credentials and, thus, that the credentials have been compromised), and so forth.

The one or more remediation actions may be initiated based on prioritization which may be applied for communications identified as being malicious. The prioritization may depend on the workflow involved (e.g., a business impact of the workflow), an importance of the user that is impacted, the type of malicious activity detected, and so forth.

The one or more remediation actions may be initiated locally (e.g., by a system which detected the malicious communication), initiated by sending a message (e.g., a notification, a request, and so forth) to one or more other systems (e.g., one or more corporate control systems, a security control system, and so forth), and so forth.

It will be appreciated that the initiation of one or more remediation actions based on a determination that the communication is a malicious activity may be performed in various other ways.

It will be appreciated that, although primarily presented herein with respect to use of social engineering attack prevention for early detection of social engineering attacks for specific types of workflows (namely, workflows based on communications (e.g., emails, text messages, voice communications, or the like), use of websites, use of applications, and so forth) of a specific type of environment (namely, a corporate network) to protect specific types of entities (namely, internal and external users of a corporation and the corporate network of the corporation), various examples of social engineering attack prevention presented herein may be used for early detection of social engineering attacks for other types of workflows (e.g., based on other types of interactions in addition to or in place of communications, user interactions, or the like), for other types of environments (e.g., access networks, core networks, datacenters, or the like), to protect other types of entities (e.g., other types of users, devices, and so forth), and so forth.

It will be appreciated that various examples of social engineering attack prevention may be applied to various types of malicious activity, some examples of which follow.

In one example, social engineering attack prevention may be used for detection and handling of corporate spear phishing attacks. In this example, the bad actor identifies the visual look of a company's official employee login page (e.g., via an Internet search or other source of such information). The bad actor then creates a phishing site using the look of the company's official employee login page. The bad actor then hosts the phishing site using a URL appearing to be from the company. The bad actor then begins small phishing campaigns targeting employees at that company (e.g., by posing as an automated system and sending an email to an internal user at the company saying that a performance review for the internal user is ready and including a link to the URL). It will be appreciated that, depending on deployment and operation of social engineering attack prevention by the company, the email may be identified and blocked before the internal user even receives it or may be identified and remediated after the user receives the email in response to the user opening the email or clicking the URL in the email. In either case, the social engineering attack prevention functions would review the URL in the body of the email and, based on a determination that the URL uses patterns similar to corporate URLs of the company while not being from the company, would flag the site for further review before allowing the user to access the site (e.g., before delivering the email to the user or before directing the user to the site where the user has received the email and clicked the link in the email). The ML analysis may then access the site and perform a comparison to the official corporate portal templates. If the site matches any of the corporate templates, the site may be flagged for phishing. If the site is flagged for phishing, one or more of the following remediation steps may be initiated: automatically add a proxy block for the site and update site categorization, automatically initiate a takedown request, automatically inform browser blocking services, automatically block future messages matching this attack campaign (e.g., based on one or more of sender, verbiage, URL match, and so forth), automatically reset user credentials of the user if the analysis was due to a URL clicked event in which the email was delivered to the user and the user clicked the URL (here, for safety purposes, it is assumed the user entered his or her credentials and, thus, that the credentials have been compromised), and so forth.

In one example, social engineering attack prevention may be used for detection and handling of customer care voice call phishing attacks. In this example, the bad actor, such as a robocaller, calls a customer about his account starting that there is a problem with the account (e.g., stating that the account is outstanding in terms of payment being due, stating that abnormal activity was detected on the account, and so forth) and guiding the customer to press a key to talk to a live agent or to call a specific number to talk to a live agent. In general, many large companies will initiate calls to their customers in which they introduce themselves and give out guidance in certain formats/templates. The bad actors initiating the phishing attacks will copy these formats/templates in order to make their fake accounts sound as if they are really from the company. In this example, the social engineering attack prevention functions may review the phone number associated with the call and, based on a determination that the phone number uses patterns similar to telephone numbers of the company while not being from the company (e.g., the caller number is not an official corporate number), would flag the voice call for further review. The ML analysis may then access the voice call and perform analysis of the call (e.g., performing audio analysis on the audio of the voice call, performing text analysis on a text transcript of the voice call (e.g., where a speech-to-text transcript may be generated from the audio of the voice call), or the like) to determine whether the voice call is a legitimate call or a phishing attempt. In this case, based on a determination that the voice call is a phishing attempt, one or more of the following remediation steps may be initiated: automatically inform call blocking services, automatically block future calls matching this attack campaign (e.g., based on one or more of number, verbiage, and so forth), automatically reset user credentials of the user if the analysis was due to a user initiated event in which the voice call was delivered to the user and the user initiated an action based on the voice call such as pressing a key or dialing a number (here, for safety purposes, it is assumed the user provided his or her credentials and, thus, that the credentials have been compromised), and so forth.

In one example, social engineering attack prevention may be used for detection and handling of customer phishing attacks. In this example, a bad actor identifies the visual look of a company's official web page (e.g., via an Internet search or other source of such information). The bad actor then creates a phishing site using the look of the company's official web page. The bad actor then hosts the phishing site using a URL appearing to be from the company (i.e., the bad actor may use squatting domains using URLs that look, to untrained or inattentive customers, to belong to the company). The ML analysis may be applied to the site in order to identify the site as a customer phishing site. The ML analysis may identify the site as a customer phishing site by accessing the site and performing a comparison of the site to the official corporate customer templates for customer facing sites of the company. If the site matches any of the corporate templates, the site may be flagged as being a phishing site. If the site is flagged as being a phishing site, one or more of the following remediation steps may be initiated: automatically add a proxy block for the site and update site categorization, automatically initiate a takedown request, automatically inform browser blocking services, automatically reset user credentials of the user if the analysis was due to a URL clicked event in which the email was delivered to the user and the user clicked the URL (here, for safety purposes, it is assumed the user entered his or her credentials and, thus, that the credentials have been compromised), and so forth.

It will be appreciated that various examples of social engineering attack prevention may be applied to various other types of malicious activity.

It should be noted that the system 100 has been simplified. Thus, it should be noted that the system 100 may be implemented in a different form than that which is illustrated in FIG. 1. For example, system 100 may be expanded by including additional networks, devices, and so forth, without altering the scope of the present disclosure. For example, the system 100 may be altered to omit various elements, substitute elements for devices that perform the same or similar functions, combine elements that are illustrated as separate devices, and/or implement network elements as functions that are spread across several devices that operate collectively as the respective network elements, without altering the scope of the present disclosure. For example, the system 100 may include networks (not shown) in addition to corporate networks 110. For example, the system 100 may include networks (not shown) in addition to communication network 120. In addition, the system 100 may include other network elements (not shown) such as policy servers, security devices, or the like. It will be appreciated that the system 100 may be modified in various other ways while still supporting social engineering attack prevention in accordance with the present disclosure. Thus, these and other modifications are contemplated within the scope of the present disclosure.

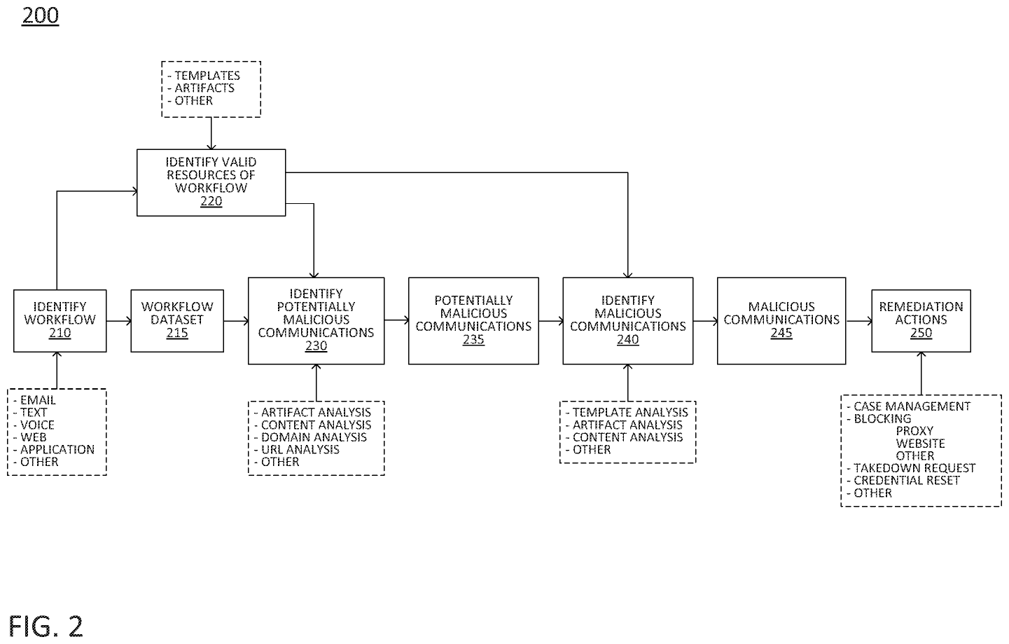

FIG. 2 illustrates an example process of supporting social engineering attack prevention for a corporate network. It will be appreciated that the process 200 may be performed within the context of the system 100 of FIG. 1.

At block 210, a workflow is identified. The workflow that is identified is the workflow to be protected. The workflow may be identified based on a set of users to be protected, a type of communication or communications to be protected, one or more activities to be protected, and so forth.

As illustrated in FIG. 2, the workflow may be based on various types of interactions, such as various types of communication interactions (e.g., email, text, voice, video, and the like), various types of user interactions (e.g., web, application, and the like), and so forth.

As further illustrated in FIG. 2, the identification of the workflow 210 enables obtaining of a workflow dataset 215 associated with the workflow. The workflow dataset 215 includes various types of data produced within the context of the workflow, or otherwise associated with the workflow, which may be monitored and analyzed for identifying and preventing malicious communications. For example, the workflow dataset 215 may include emails where the workflow includes email communications, text messages where the workflow includes text message communications, voice calls where the workflow includes voice call communications, videos where the workflow includes video communications, requests for web pages and responses with web pages where the workflow includes interaction with web pages, requests for applications user interfaces and responses with application user interfaces where the workflow includes interaction with applications, and so forth.

As further illustrated in FIG. 2, the identification of the workflow 210 enables identification of valid resources of the workflow (as discussed further with respect to block 220) which may be used for identification and remediation of malicious communications within the context of the workflow.

At block 220, valid resources of the workflow are identified. As illustrated in FIG. 2, the valid resources of the workflow may include templates, artifacts, and so forth.

At block 230, potentially malicious communications of the workflow are identified from the workflow dataset 215 based on the valid resources of the workflow as identified at block 220 (illustrated as potentially malicious communications 235 output from block 230). As illustrated in FIG. 2, the identification of potentially malicious communications 235 of the workflow from the workflow dataset 215 may be based on one or more of artifact analysis (e.g., using one or more filters created based on one or more artifacts of the workflow), content analysis (e.g., text based analysis, image based analysis, audio based analysis, video based analysis, or the like), domain analysis, URL analysis, and so forth.

At block 240, malicious communications of the workflow are identified from the potentially malicious communications 235 based on the valid resources of the workflow as identified at block 220 (illustrated as malicious communications 245 output from block 240). As illustrated in FIG. 2, the identification of the malicious communications 245 of the workflow from the potentially malicious communications 235 may be based on one or more of template analysis, artifact analysis, content analysis (e.g., text based analysis, image based analysis, audio based analysis, video based analysis, or the like), and so forth.

At block 250, remediation actions are initiated for the malicious communications 245 of the workflow. As illustrated in FIG. 2, the remediation actions for the malicious communications 245 may include case management, one or more types of blocking (e.g., proxy, website, or the like), takedown requests, credential resets, and so forth.

It will be appreciated that various other functions for supporting social engineering attack prevention as discussed within the context of system 100 of FIG. 1 may be applied within the context of process 200 of FIG. 2.

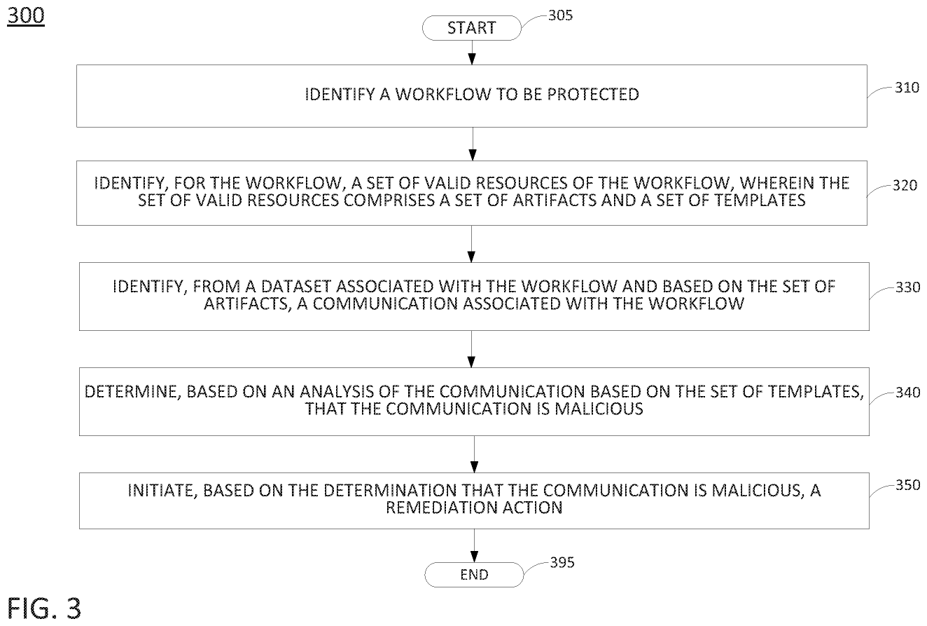

It will be appreciated that various functions for supporting social engineering attack prevention as discussed within the context of system 100 of FIG. 1 and within the context of process 200 of FIG. 2 may be further understood by way of reference to FIG. 3.

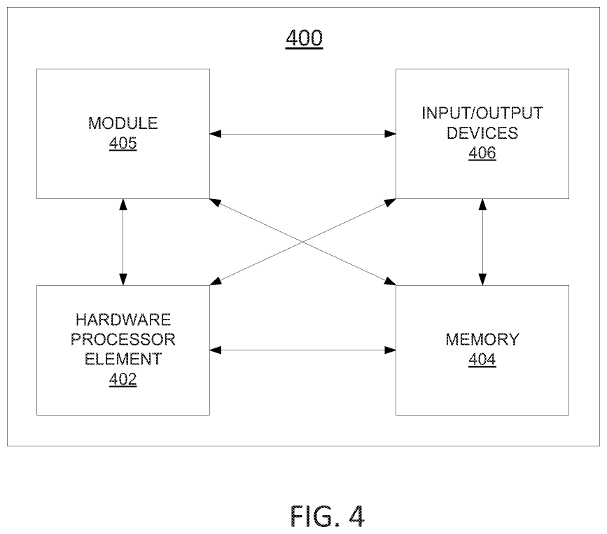

FIG. 3 illustrates a flowchart of an example method for supporting social engineering attack prevention. In one example, the method 300 is performed by a system operating within a network (e.g., a corporate system 111 of a corporate network 110 of FIG. 1, a communication system 121 of a communication network 120 of FIG. 1, and so forth). In one example, the method 300 is performed by a management system (e.g., management system 130 of FIG. 1). In one example, the steps, functions, or operations of method 300 may be performed by a computing device or processing system, such as the computing system 400 and/or hardware processor element 402 as described in connection with FIG. 4 below. For instance, the computing system 400 may represent any one or more components of the system 100 that is/are configured to perform the steps, functions and/or operations of the method 300. Similarly, in one example, the steps, functions, or operations of the method 300 may be performed by a processing system including one or more computing devices collectively configured to perform various steps, functions, and/or operations of the method 300. For instance, multiple instances of computing system 400 may collectively function as a processing system. For illustrative purposes, the method 300 is described in greater detail below in connection with an example performed by a processing system.

As illustrated in FIG. 3, the method 300 begins in step 305 and proceeds to step 310.

At step 310, the processing system may identify a workflow to be protected. In one example, the workflow may be identified based on at least one of an email, a text message, a voice communication, a video, a website interaction, or an application interaction. In one example, the workflow may be identified based on an identification of a set of users able to interact with the workflow.

At step 320, the processing system may identify, for the workflow, a set of valid resources of the workflow, wherein the set of valid resources includes a set of artifacts and a set of templates. In one example, the set of artifacts is identified from the set of templates.

At step 330, the processing system may identify, from a dataset associated with the workflow and based on the set of artifacts, a communication associated with the workflow. In one example, the communication may be identified based on application of a set of filters to the dataset associated with the workflow. In one example, the set of filters is created based on the set of artifacts. In one example, the communication may be identified based on a determination that the communication is associated with an unknown source and based on a determination that one or more elements of the communication are similar to one or more artifacts of the set of artifacts.

At step 340, the processing system may determine, based on an analysis of the communication based on the set of templates, that the communication is malicious.

In one example, the analysis of the communication may be based on a learning algorithm. In one example, the learning algorithm may include at least one of an ML algorithm or a DL algorithm. In one example, the communication has text data associated therewith (e.g., included within the communication, obtained based on the communication, and so forth), wherein the learning algorithm is based on at least one of an RNN or a latent semantic indexing. In one example, the communication has image data associated therewith (e.g., included within the communication, obtained based on the communication (e.g., an image of a web page accessed based on a URL in the communication, an image of an application user interface accessed based on the communication, or the like), and so forth), wherein the learning algorithm is based on a CNN. In one example, the communication has voice data associated therewith (e.g., included within the communication, obtained based on the communication, and so forth), wherein the learning algorithm is based on a spectrogram-based auto-encoder. In one example, the communication has video data associated therewith (e.g., included within the communication, obtained based on the communication, and so forth), wherein the learning algorithm is based on an RNN.

In one example, the learning algorithm may be configured to extract, from the set of artifacts, a set of features of the artifacts, extract, from the communication, a set of features of the communication, and determine, based on an analysis of the set of features of the artifacts and the set of features of the communication, that the communication is malicious. In one example, the determination that the communication is malicious may be based on a determination that the set of features of the artifacts and the set of features of the communication are similar. In one example, the analysis of the set of features of the artifacts and the set of features of the communication may be based on a distance metric.

In one example, the analysis of the communication may include at least one of an analysis of a source associated with the communication, an analysis of a domain associated with the communication, or an analysis of a resource identifier associated with the communication.

At step 350, the processing system may initiate, based on the determination that the communication is malicious, a remediation action. In one example, the remediation action may include at least one of a case management action, a blocking action for blocking the communication, a takedown action for initiating a takedown of a malicious website indicated within the communication, or a credential reset action for resetting a credential of at least one user associated with the communication.

As illustrated in FIG. 3, following step 350, the method 300 proceeds to step 395 where the method 300 ends.

It will be appreciated that the method 300 may be expanded to include additional steps, or may be modified to replace steps with different steps, to combine steps, to omit steps, to perform steps in a different order, and so forth. For instance, in one example the processing system may repeat one or more steps of the method 300. Thus, it will be appreciated that these and other modifications are all contemplated within the scope of the present disclosure.

It will be appreciated that, although not expressly specified above, one or more steps of the method 300 may include a storing, displaying, and/or outputting step as required for a particular application. In other words, any data, records, fields, and/or intermediate results discussed in the method 300 can be stored, displayed, and/or outputted to another device as required for a particular application. Furthermore, operations, steps, or blocks in FIG. 3 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative example and is not intended to indicate that steps not labelled as optional steps to be deemed to be essential steps. Furthermore, operations, steps, or blocks of method 300 can be combined, separated, and/or performed in a different order from that described above, without departing from the examples of the present disclosure.

It will be appreciated that various examples of social engineering attack prevention presented herein may provide various advantages or potential advantages. For example, various examples of social engineering attack prevention presented herein may provide companies with various tools that will enable the companies to quickly identify and remediate potential targeted social engineering attempts toward their users (e.g., employees, customers, or the like). For example, various examples of social engineering attack prevention presented herein may enable companies to quickly determine the validity of communications to their users (e.g., employees, customers, or the like) based on identification of templates for valid corporate workflows (e.g., employee login portal UIs, corporate IPs/domains and URL structures, and so forth) and to take appropriate actions based on detection of invalid communications which may be targeted social engineering attacks. For example, various examples of social engineering attack prevention presented herein may enable companies to prioritize incidents based on the business impact of the associated workflow. For example, various examples of social engineering attack prevention presented herein may enable companies to automatically control various corporate security solutions based on detection of targeted social engineering attacks by feeding results into the various corporate security solutions to trigger various security actions (e.g., preventing text messages from being received, preventing emails from reaching inboxes, blocking access to websites, and so forth). For example, various examples of social engineering attack prevention presented herein may be applied to various types of communications which assailants may use to try to trick users (e.g., email, text, voice, websites, applications, and so forth). For example, various examples of social engineering attack prevention presented herein may be applied so as to prevent any compromise from occurring (e.g., before the first user is able to access the malicious content). For example, various examples of social engineering attack prevention presented herein may be able to support quick and early identification of targeted social engineering attacks, verification of the accuracy of findings, and initiation of necessary remediation steps, thereby allowing the threat analytics team to get ahead of threats by detecting and remediating threats well in advance of when the threats might otherwise be identified in the absence of social engineering attack prevention (where it will be appreciated that this difference in time saves resources that otherwise would be spent on threat detection), deny access to a threat actor (and, thus, deny the threat actor the possibility of performing reconnaissance, engaging in fraud and other potential financially devastating activities, and so forth), save the collective time lost by potential victims who would be left without access in the absence of social engineering attack prevention, and so forth. For example, various examples of social engineering attack prevention presented herein may be able to handle relatively large scale attacks as well as relatively small scale attacks that might not otherwise be detected with certain vendor solutions due to the attack being in its early stages or targeted to a relatively small group. It will be appreciated that various examples of social engineering attack prevention presented herein may provide various other advantages or potential advantages.

It will be appreciated that, as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may include a computing device, or computing system, including one or more processors, or cores (e.g., as illustrated in FIG. 4 and discussed below) or multiple computing devices collectively configured to perform various steps, functions, and/or operations in accordance with the present disclosure.

FIG. 4 depicts a high-level block diagram of a computing system 400 (e.g., a computing device or a processing system) specifically programmed to perform functions described herein. For example, any one or more components or devices illustrated in FIG. 1 or FIG. 2, or described in connection with the method 300 of FIG. 3, may be implemented as the computing system 400. As depicted in FIG. 4, the computing system 400 includes a hardware processor element 402 (e.g., including one or more hardware processors, which may include one or more microprocessor(s), one or more central processing units (CPUs), and/or the like, where the hardware processor element 402 also may represent one example of a “processing system” as referred to herein), a memory 404, (e.g., random access memory (RAM), read only memory (ROM), a disk drive, an optical drive, a magnetic drive, and/or a Universal Serial Bus (USB) drive), a module 405 for supporting social engineering attack prevention, and one or more input/output devices 406, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, or the like).

It will be appreciated that, although only one hardware processor element 402 is shown, the computing system 400 may employ a plurality of hardware processor elements. Furthermore, although only one computing device is shown in FIG. 4, if the method(s) as discussed above is implemented in a distributed or parallel manner for a particular illustrative example, e.g., the steps of the above method(s) or the entire method(s) are implemented across multiple or parallel computing devices, then the computing system 400 of FIG. 4 may represent each of those multiple or parallel computing devices. Furthermore, one or more hardware processor elements (e.g., hardware processor element 402) can be utilized in supporting a virtualized or shared computing environment. The virtualized computing environment may support one or more virtual machines which may be configured to operate as computers, servers, or other computing devices. In such virtualized virtual machines, hardware components such as hardware processors and computer-readable storage devices may be virtualized or logically represented. The hardware processor element 402 can also be configured or programmed to cause other devices to perform one or more operations as discussed above. In other words, the hardware processor element 402 may serve the function of a central controller directing other devices to perform the one or more operations as discussed above.

It will be appreciated that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer-readable instructions pertaining to the method(s) discussed above can be used to configure one or more hardware processor elements to perform the steps, functions and/or operations of the above disclosed method(s). In one example, instructions and data for the module 405 for supporting social engineering attack prevention (e.g., a software program include computer-executable instructions) can be loaded into memory 404 and executed by hardware processor element 402 to implement the steps, functions or operations as discussed above in connection with the example method 300. Furthermore, when a hardware processor element executes instructions to perform operations, this could include the hardware processor element performing the operations directly and/or facilitating, directing, or cooperating with one or more additional hardware devices or components (e.g., a co-processor or the like) to perform the operations.

The processor (e.g., hardware processor element 402) executing the computer-readable instructions relating to the above described method(s) can be perceived as a programmed processor or a specialized processor. As such, the module 405 for supporting social engineering attack prevention (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette or the like. Furthermore, a “tangible” computer-readable storage device or medium may comprise a physical device, a hardware device, or a device that is discernible by the touch. More specifically, the computer-readable storage device or medium may comprise any physical devices that provide the ability to store information such as instructions and/or data to be accessed by a processor or a computing device such as a computer or an application server.

While various examples have been described above, it should be understood that they have been presented by way of example only, and not limitation. Thus, the breadth and scope of a preferred example should not be limited by any of the above-described examples, but should be defined only in accordance with the following claims and their equivalents.

What is claimed is:

1. A method, comprising:
identifying, by a processing system including at least one processor, a workflow to be protected;
identifying, by the processing system for the workflow, a set of valid resources of the workflow, wherein the set of valid resources includes a set of artifacts and a set of templates;
identifying, by the processing system from a dataset associated with the workflow and based on the set of artifacts, a communication associated with the workflow;
determining, by the processing system based on an analysis of the communication based on the set of templates, that the communication is malicious; and
initiating, by the processing system based on the determination that the communication is malicious, a remediation action.

2. The method of claim 1, wherein the workflow is based on at least one of an email, a text message, a voice communication, a video, a website interaction, or an application interaction.

3. The method of claim 1, wherein the workflow is identified based on an identification of a set of users able to interact with the workflow.

4. The method of claim 1, wherein the set of artifacts is identified from the set of templates.

5. The method of claim 1, wherein the communication is identified based on application of a set of filters to the dataset associated with the workflow.

6. The method of claim 5, wherein the set of filters is created based on the set of artifacts.

7. The method of claim 1, wherein the communication is identified based on a determination that the communication is associated with an unknown source and based on a determination that one or more elements of the communication are similar to one or more artifacts of the set of artifacts.

8. The method of claim 1, wherein the analysis of the communication is based on a learning algorithm.

9. The method of claim 8, wherein the learning algorithm includes at least one of a machine learning (ML) algorithm or a deep learning (DL) algorithm.

10. The method of claim 8, wherein the communication has text data associated therewith, wherein the learning algorithm is based on at least one of a recurrent neural network (RNN) or a latent semantic indexing.

11. The method of claim 8, wherein the communication has image data associated therewith, wherein the learning algorithm is based on a convolutional neural network (CNN).

12. The method of claim 8, wherein the communication has voice data associated therewith, wherein the learning algorithm is based on a spectrogram-based auto-encoder.

13. The method of claim 8, wherein the communication has video data associated therewith, wherein the learning algorithm is based on a recurrent neural network (RNN).

14. The method of claim 8, wherein the learning algorithm is configured to:
extract, from the set of artifacts, a set of features of the artifacts;
extract, from the communication, a set of features of the communication; and
determine, based on an analysis of the set of features of the artifacts and the set of features of the communication, that the communication is malicious.

15. The method of claim 14, wherein the determination that the communication is malicious is based on a determination that the set of features of the artifacts and the set of features of the communication are similar.

16. The method of claim 1, wherein the analysis of the communication includes at least one of an analysis of a source associated with the communication, an analysis of a domain associated with the communication, or an analysis of a resource identifier associated with the communication.

17. The method of claim 1, wherein the remediation action includes at least one of a case management action, a blocking action for blocking the communication, a takedown action for initiating a takedown of a malicious website indicated within the communication, or a credential reset action for resetting a credential of at least one user associated with the communication.

18. The method of claim 1, wherein the determining that the communication is malicious comprises an early detection of a low-volume targeted attack.

19. An apparatus comprising:
a processing system including at least one processor; and
a computer-readable medium storing instructions which, when executed by the processing system, cause the processing system to perform operations, the operations comprising:
identifying a workflow to be protected;
identifying, for the workflow, a set of valid resources of the workflow, wherein the set of valid resources includes a set of artifacts and a set of templates;
identifying, from a dataset associated with the workflow and based on the set of artifacts, a communication associated with the workflow;
determining, based on an analysis of the communication based on the set of templates, that the communication is malicious; and
initiating, based on the determination that the communication is malicious, a remediation action.

20. A non-transitory computer-readable medium storing instructions which, when executed by a processing system including at least one processor, cause the processing system to perform operations, the operations comprising:
identifying a workflow to be protected;
identifying, for the workflow, a set of valid resources of the workflow, wherein the set of valid resources includes a set of artifacts and a set of templates;
identifying, from a dataset associated with the workflow and based on the set of artifacts, a communication associated with the workflow;
determining, based on an analysis of the communication based on the set of templates, that the communication is malicious; and
initiating, based on the determination that the communication is malicious, a remediation action.
